(19) United States
(12) Patent Application Publication
(10) Pub. No.: US 2026/0213102 A1
(43) Pub. Date: Jul. 23, 2026

(54) CIRCUIT BREAKER

(71) Applicant: Ellenberger & Poensgen GmbH, Altdorf (DE)

(72) Inventors: Manuel ENGEWALD, Nuernberg (DE); Jakob SEISSLER, Nuernberg (DE); Lothar HOFMEISTER, Neumarkt (DE); Markus BIRNER, Zirndorf (DE); Markus MIKLIS, Schwarzenbruck (DE); Ricardo PIMENTA, Eckental (DE)

(73) Assignee: Ellenberger & Poensgen GmbH, Altdorf (DE)

(21) Appl. No.: 19/556,499

(22) Filed: Mar. 4, 2026

Related U.S. Application Data
(63) Continuation of application No. PCT/EP2024/072578, filed on Aug. 9, 2024.

(30) Foreign Application Priority Data
Sep. 6, 2023 (DE) 10 2023 208 606.9

(51) Int. Cl. H01H 50/54; H01H 50/04; H01H 50/32; H01H 50/36

(52) U.S. Cl. CPC H01H 50/546; H01H 50/045; H01H 50/32; H01H 50/36; H01H 50/541; H01H 2050/362

(57) ABSTRACT

A circuit breaker which has a busbar to which a fixed contact is attached, and a contact bridge which is mounted movably relative thereto and to which a moving contact is attached. The circuit breaker also comprises an electric drive by means of which the contact bridge is driven, a yoke placed around the busbar, and a movably mounted slider to which an armature is attached. The circuit breaker is configured such that, when a first limit value is exceeded by an electric current conducted via the busbar, the slider is moved on account of a magnetic interaction between the armature and the yoke and therefore, by means of the slider, a switch element connected electrically in series with the electric drive is actuated.

This nonprovisional application is a continuation of International Application No. PCT/EP2024/072578, which was filed on Aug. 9, 2024, and which claims priority to German Patent Application No. 10 2023 208 606.9, which was filed in Germany on Sep. 6, 2023, and which are both herein incorporated by reference.

### BACKGROUND OF THE INVENTION

### Field of the Invention

The invention relates to a circuit breaker. The circuit breaker has a busbar to which a fixed contact is connected, a contact bridge which is movably mounted relative thereto, and an electrical drive, with the aid of which the contact bridge is driven.

### Description of the Background Art

To an increasing degree, motor vehicles have an electric motor for propulsion. To supply current to the electric motor, an energy store is usually used, which is designed, for example, as a so-called high-voltage battery. A comparatively high electrical DC voltage is provided with the aid of the energy store, which is, for example, greater than 500 V and with the aid of which a vehicle electrical system is supplied, to which the electric motor is electrically connected. The electrical currents flowing between the vehicle electrical system and the energy store may be several 100 A, in particular, if the motor vehicle is comparatively heavy, as in the case, for example, of a commercial vehicle. In an emergency, such as an accident, a malfunction of the electric motor, and/or a short-circuit of the vehicle electrical system, it is therefore necessary to disconnect the energy store from the vehicle electrical system as quickly as possible to avoid an injury to aid workers or users of the motor vehicle. The flowing electrical currents, which then exist, in particular in the case of an overcurrent/short-circuit current, may result in a thermal overloading of the vehicle electrical system and/or the energy store. A circuit breaker, for example, may be used for disconnection.

A circuit breaker of this type usually has a switching element, which is connected between the energy store and the vehicle electrical system. The switching element is driven, for example, with the aid of a control unit, which is connected via signals to a current sensor. The electrical current flowing over the switching element may be measured thereby during operation. If it is higher than a limit value, the switching element is driven to open with the aid of the control unit, so that the electrical current flow between the energy store and the vehicle electrical system is interrupted. Since a semiconductor switch has a high inner resistance as a matter of principle, even in the electrically conductive state, a relay is usually used as the switching element, which comprises a mechanical switch, which is driven with the aid of an electrical drive. However, a switching time is increased in the case thereof, due to the mechanical design. In connection with the necessary evaluation of the measured values provided with the aid of the current sensor, this results in the fact that the time period between exceeding the limit value and the actual interruption of the current flow is comparatively long. Due to the comparatively high currents, a damage to the vehicle electrical system or further components of the motor vehicle is therefore still possible.

### SUMMARY OF THE INVENTION

It is therefore an object of the invention is to specify a particularly suitable circuit breaker, an operating safety being advantageously increased.

The circuit breaker is used, for example, to protect a device, and the circuit breaker is, for example, a device circuit breaker. Alternatively or in combination herewith, the circuit breaker is used to protect a line and is thus a line circuit breaker. Alternatively or in combination therewith, the circuit breaker is, for example, a battery circuit breaker and is advantageously used to protect a battery. In the mounted state, the circuit breaker is particularly preferably a constituent part of a motor vehicle which is, for example, a ship or a boat. However, the motor vehicle is preferably land-based and, for example, a locomotive. The motor vehicle is, however, particularly preferably not railbound, and is, for example, a passenger car or advantageously a commercial vehicle, in particular, a bus or a truck. Alternatively, the motor vehicle is, for example, an agricultural machine or a construction site vehicle. In the mounted state, the circuit breaker is arranged, in particular, between an energy store of the motor vehicle and a vehicle electrical system of the motor vehicle, a circuit being at least partially formed with the aid of the energy store and the vehicle electrical system. Independently of the use, the circuit-breaker is preferably suitable, in particular provided and configured, to be introduced into a circuit and to interrupt a current flow therein in the event of a fault.

The circuit breaker can comprise, in particular, two connections, between which a current path is formed and to which further constituent parts of the circuit are connected in the mounted state. The connections are suitable, in particular provided and configured, for this purpose. A cable or a busbar is advantageously connected to the particular connection for this purpose, a cross-section thereof being between, for example, 80 mm² and 100 mm². The circuit breaker is suitably provided and configured to switch an electrical voltage which is, in particular, a DC voltage. The circuit breaker is preferably provided and configured to switch an electrical (nominal or maximum) voltage of more than 200 V. In particular, the electrical voltage is less than or equal to 1,000 V or 1,500 V. The level of the electrical (nominal or maximum) current switchable with the aid of the circuit breaker is greater than 50 A, 100 A, or 200 A. In particular, the electrical current is less than 20,000 A, 10,000 A, or 5,000 A. In particular, the switching capacity of the circuit breaker is one of these values. The circuit breaker has, in particular, two different states, namely an electrically conductive (closed) state and an electrically non-conductive (open) state. In particular, the electrical current is conducted between the two connections in the mounted state when the circuit breaker is in the electrically conductive state.

In the electrically non-conductive state, however, the electrical current is interrupted, and, in particular, the electrical voltage is present at the connections.

The circuit breaker has a busbar, to which a fixed contact is connected. The busbar is formed, in particular, with the aid of a metal part, such as a metal strip, which is preferably made from an aluminum or a copper. In particular, the busbar is electrically contacted by one of the possible connections, in particular, in a rigid manner. The connection and the fixed contacts are suitably assigned to opposite ends of the busbar. The fixed contact is made, for example, from the same material as the busbar and is, for example, flush therewith. In other words, the fixed contact is formed, in particular, with the aid of an constituent part of the same metal part. Alternatively, the fixed contact is made from a different material, in which a burn-off safety is increased and/or a volume resistance/transfer resistance is reduced. The fixed contact preferably projects over the busbar and is thus raised.

The circuit breaker furthermore comprises a contact bridge, which is also movably supported in relation to the busbar and thus also to the fixed contact. A moving contact is connected to the contact bridge. The contact bridge is advantageously also formed with the aid of the metal part and is made, for example, from the same metal as the busbar or at least from an aluminum or copper. The number of different materials is reduced in this way. In particular, the busbar and the contact bridge are made from the same semi-finished product, for which reason costs are reduced. The moving contact is suitably rigidly fastened to the contact bridge and is, for example, flush therewith. However, the moving contact particularly preferably projects over the contact bridge and is thus raised. The moving contact is made, for example, from the same material as the contact bridge or preferably from a different material, in which the burn-off safety is increased.

The circuit breaker suitably has a support, which comprises, in particular, a bearing, with the aid of which the contact bridge is correspondingly supported. The contact bridge is advantageously supported in such a way that it is possible to mechanically place the moving contact directly against the fixed contact and also move it away therefrom. When the moving contact rests against the fixed contact, an electrical current flow is possible between the busbar and the contact bridge over the fixed contact and the moving contact. If this is the case, the circuit breaker is, in particular, in the electrically conductive state. It is also possible to move the fixed contact away from the moving contact, in particular, with the aid of the support, so that they do not rest against each other mechanically. The at least implementable distance is, for example, greater than 2 mm, 3 mm, 5 mm, or 1 cm. When the moving contact is situated at a distance from the fixed contact, the contact bridge, in particular, is galvanically isolated from the busbar.

The contact bridge can be suitably electrically contacted with the possible other connection, for example, directly or via further constituent parts. The busbar, the contact bridge, the moving contact, and the fixed contact are preferably constituent parts of the possible current path formed between the two connections. When the moving contact rests against the fixed contact, the circuit breaker is advantageously in the electrically conductive state. When the moving contact is situated at a distance from the fixed contact, the circuit breaker is, in particular, in the electrically non-conductive state.

The circuit-breaker further can comprise an electrical drive, with the aid of which the contact bridge is driven. The contact bridge is moved, in particular, during the operation of the electrical drive and/or during a change in the operation of the electrical drive. The electrical drive advantageously has a drive coil, which is an electrical coil. A movably supported coil armature is arranged within the latter, which is, in particular, a permanent magnet or is at least made from a magnetic material, such as a ferromagnetic or ferrimagnetic material. The coil armature is connected to the contact bridge, preferably with the aid of a coupling rod. When current is supplied to the drive coil, a magnetic field is generated by means thereof, so that the coil armature moves and, as a result, also the contact bridge connected to the coil armature.

For example, the in particular electrical drive can be provided with a bistable design and, in particular, in the case of a corresponding one-time supply of current to the electrical drive, the position of the contact bridge changes. When the latter is in the desired position, in which the moving contact is situated at a distance from the fixed contact or rests against it, the contact bridge remains in this position even when the supply of current to the electrical drive ends. To change the position of the contact bridge, a new, correspondingly adapted current supply to the electrical drive is necessary in each case.

However, the electrical drive particularly may only have a monostable design. The contact bridge is held in one of the two positions, in particular, by operating the electrical drive. When the operation of the electrical drive is ended, in particular, the current supply thereto, the contact bridge is moved into the other position. A further force, which is provided, in particular, by means of a spring of the electrical drive, is advantageously additionally applied to the contact bridge for this purpose. The contact bridge is transferred, in particular, into the stable position thereby, while, an oppositely acting, higher force is applied thereto with the aid of the electrical drive during the operation thereof. In particular, the electrical drive, or at least the circuit breaker, is designed in such a way that, when the operation of the electrical drive does not take place, the fixed contact is situated at a distance from the moving contact/moved away therefrom, which increases a safety.

The circuit breaker furthermore can have a yoke, which is placed around the busbar. The yoke at least partially surrounds the busbar and is preferably situated at a distance therefrom. The yoke is suitably galvanically isolated from the busbar, so that they may have, in particular, different electrical potentials. The yoke is preferably provided with an essentially annular, O-shaped, or U-shaped design and advantageously has an opening, so that the yoke is not completely closed. The yoke preferably does not completely surround the busbar. The yoke is made, in particular, from a magnetic material, in particular, a soft magnetic material, for example, a ferromagnetic or ferrimagnetic material. In particular, however, the yoke is not itself a permanent magnet. The yoke is suitably made from a soft iron or transformer plate. In particular, the yoke is designed and arranged in such a way that a magnetic field is induced therein when an electrical current is conducted via the busbar. At least, a magnetic field surrounding the busbar, which results due to an electrical current flowing through the busbar, is advantageously focused with the aid of the yoke. In particular, an air gap is present due to the opening.

The circuit breaker furthermore can comprise a slide, which is movably supported. The slide is advantageously provided with an electrically non-conductive and/or non-magnetic design. In particular, the slide can be made from a paramagnetic or diamagnetic material and advantageously from a plastic. Manufacturing costs are thus reduced. An armature is connected to the slide, which is, for example, a permanent magnet or is manufactured from a soft magnetic material. In other words, the armature is made from a ferrimagnetic or ferromagnetic material, such as ferrite. Alternatively, for example, the armature is manufactured from a steel. In particular, the armature is fastened to the slide. For example, they are glued to each other, or the slide has a pocket within which the armature is arranged. In one alternative, the slide comprises, for example, latching elements, with the aid of which the armature is latched. At least, the armature is moved along with the movement of the slide, preferably in the same direction and by the same amount and advantageously also in reverse.

The circuit breaker can be designed in such a way that, when a first limit value is exceeded by the electrical current conducted via the busbar, which is equal to the current conducted with the aid of the circuit breaker or at least the current path, the slide is moved between the armature and the yoke due to a magnetic interaction. In other words, in particular, the yoke is arranged in such a way that the electrical current conducted via the busbar induces or at least gives rise to a magnetic field in the yoke, which interacts with the armature, advantageously with the aid of a magnetic field provided by the armature. The armature is correspondingly magnetized and/or positioned for this purpose, so that a magnetic field is induced there as well. Alternatively or in combination therewith, magnetic field lines are focused with the aid of the armature, which are provided, in particular, with the aid of the yoke. Only when the electrical current exceeds the first limit value is the slide moved, at least to the degree which is the case from the time the first limit value is exceeded. if the electrical current is below the first limit value, the magnetic interaction, i.e., in particular, the magnetic force active between the yoke and the armature, is insufficient to move the slide. The circuit breaker is designed accordingly for this purpose. For example, a friction of the support of the slide is too high and/or a further mechanism is present, which comprises, for example, a spring. In other words, the slide is advantageously spring-loaded. Alternatively or in combination therewith, the yoke is designed, for example, in such a way that only a comparatively small number of magnetic field lines are focused with the aid thereof, provided that the electrical current remains below the first limit value. The armature and the yoke, in particular the possible opening, are advantageously adapted accordingly for this purpose.

When the slide can be moved upon exceeding the first limit value, due to the magnetic interaction, a switching element is actuated with the aid thereof, which is electrically connected in series to the electrical drive. The supply of current to the electrical drive changes due to the actuation of the switching element. For example, a supply of current to the electrical drive is begun or particularly preferably interrupted. Due to the changed current supply to the electrical drive, at least the position of the contact bridge is changed, and the circuit breaker is thus transferred into a different state, in particular, into the electrically non-conductive state. The circuit breaker, in particular, is adapted accordingly for this purpose.

The armature can be advantageously situated at a distance from the yoke or at least from the possible opening, at least when the switching element is not actuated with the aid of the slide. However, a distance of the armature from the yoke, in particular relative to the possible opening, is reduced when the switching element is actuated or at least during a movement of the slide in the direction of the switching element for the purpose of actuating it. The slide is suitably supported accordingly for this purpose.

In summary, it is thus preferred to place the circuit breaker into the electrically non-conductive state when the first limit value is exceeded by the conducted electrical current. It is possible to provide the slide and the armature connected thereto with a comparatively lightweight design. In particular, the mass of the slider to be moved is lower than, for example, the mass of the contact bridge. When the first limit value is exceeded, the slide is thus moved comparatively rapidly, due to the low mass thereof and the magnetic forces which then prevail. The switching element is thus actuated comparatively quickly after the first limit value is exceeded and therefore, in particular, the flowing electrical current is interrupted.

A processing of measured data relating to the electrical current or the like is also essentially not necessary, for which reason the period of time until the supply of current to the electrical drive is changed is also shortened. A number of necessary electrical/electronic components are also reduced, for which reason manufacturing costs are lowered and an error susceptibility is reduced. Since the slide, the yoke, and the armature are furthermore preferably galvanically isolated from the busbar, a special insulation is not necessary, for which reason a construction is simplified. Artifacts in the conducted electrical current also do not result in an impairment of the functionality of the slide, so that a robustness is increased. Due to the shortened switching period as well as the robust design, it is therefore always ensured that the electrical drive is actuated when the first limit value is exceeded, i.e., its operation changes, which increases an operational reliability.

For example, the electrical drive can be electrically connected to the busbar and/or the contact bridge, so that a supply of current to the electrical drive takes place with the aid of the circuit, which is protected with the aid of the circuit breaker. In other words, the electrical current conducted via the busbar, in particular, is also used for operating the electrical drive, and these are advantageously correspondingly connected to each other. However, the circuit breaker particularly preferably has a further connection for connecting a secondary circuit, with the aid of which the supply of current to the electrical drive takes place. In particular, a reduced electrical voltage is provided with the aid of the secondary circuit, which is, in particular, between 5 V and 30 V and is, in particular, equal to 12 V, 24 V, or 48 V. A requirement for the safety/isolation of the electrical drive is thus reduced. Comparatively low-power and/or cost-effective components may also be used. In addition, it is ensured in this way that, if the circuit protected with the aid of the circuit breaker malfunctions, a correct driving of the electrical drive nevertheless takes place.

The circuit breaker can also comprises an arc chute having an extinguishing element. The extinguishing element is essentially arranged adjacent to the fixed contact and/or the moving contact, and these are advantageously situated in the arc chute, which comprises, in particular, a further magnetic yoke. For example, the arc chute has a driving element, in particular a permanent magnet. If the moving contact is moved away from the fixed contact, it is possible for an arc to form therebetween. The arc chute is designed in such a way that the arc is driven into the extinguishing element, preferably with the aid of the possible driving element and/or the further magnetic yoke. The arc is, in particular, cooled and/or elongated with the aid of the extinguishing element, which has, for example, an arc splitter stack. At least the extinguishing element is designed in such a way that an electrical voltage needed to maintain the arc is increased, in particular via the electrical voltage present between the possible connections. As a result, the arc collapses, and the current flow over the circuit breaker is interrupted even if an arc has first formed between the fixed contact and the moving contact, due to which a current flow over the circuit breaker initially persisted.

The circuit breaker can have a housing, within which all other constituent parts of the circuit breaker are advantageously arranged. An anti-touch protection is thus implemented and a mounting/use made uses easier. The housing is made, in particular, from a plastic. The connections are preferably introduced into the housing, so that an electrical contacting of the constituent parts of the circuit breaker arranged in the housing is possible through the housing. The busbar is preferably rigidly connected to the housing, for example fastened or held in place there with the aid of an at least partially form-fitting contact. A construction and manufacturing are thus made easier.

In particular, the electrical drive can have a spring, which is advantageously tensioned when the moving contact rests against the fixed contact. A force applied with the aid of the spring is advantageously overcompensated for by supplying current to the electrical drive. When the supply of current to the electrical drive is ended, only the spring is essentially active which advantageously results in a movement of the moving contact away from the fixed contact.

For example, the electrical drive can be driven so that it is supplied with current due to the actuation of the switching element. However, a supply of current to the electrical drive is particularly preferably interrupted with the aid of the slide, due to the actuation of the switching element. As a result, the circuit breaker is placed, in particular, in the electrically non-conductive state, preferably with the aid of the possible spring. A safety is thus increased.

For example, the contact bridge can be rigidly fastened to the electrical drive, in particular, the possible coupling rod. However, the contact bridge is particularly preferably held on a contact bridge carrier and supported in relation thereto with the aid of a spring. The contact bridge carrier is preferably made from a plastic. During the operation of the electrical drive, the contact bridge carrier is moved and therefore also the contact bridge. When the circuit breaker is transferred into the electrically conductive state, the contact bridge carrier, including the contact bridge held thereon, continues to be moved until the moving contact is in mechanical contact with the fixed contact. A further movement of the contact bridge is subsequently hindered, and the contact bridge carrier continuous to be moved due to a further operation of the electrical drive, and the spring present between the contact bridge and the contact bridge carrier is compressed. This ensures that the moving contact rests against the fixed contact in a force-fitting manner. In this way, the mechanical contact therebetween is not released even in the case of possible vibrations of the circuit breaker, and manufacturing tolerances are compensated for. During an opening of the circuit breaker, i.e., when it is placed in the electrically non-conductive state, the contact bridge carrier is first moved with the aid of the electrical drive, and as a result the spring is relaxed. Only when the latter is fully relaxed, or, for example, when the contact bridge strikes a stop of the contact bridge carrier, is the contact bridge also moved, so that the moving contact is moved away from the fixed contact.

In particular, the yoke and the armature can be designed in such a way that a comparatively high force acts upon the slide essentially right after the first limit value is exceeded. In particular, this force is higher than in the position of the slide in which the switching element is actuated. At least the maximum of the active force is advantageously present in a position of the slide which is situated between the original position of the slide and half the distance until the actuation of the switching element. A comparatively high acceleration of the slide thus takes place as soon as the first limit value is exceeded, so that a time period until the actuation of the switching element is shortened. A force applied to the switching element with the aid of the slide is also reduced, so that the latter is not damaged. In summary, the circuit breaker is designed, in particular, in such a way that a maximum of the magnetic force active between the yoke and the armature is reached at least before the switching element is actuated, the level of the force being, in particular, dependent on the position of the slide.

In particular, the slide, or at least the circuit breaker, can be designed in such a way that the switching element remains actuated as long as the electrical current is higher than the first limit value. For example, the circuit breaker is designed in such a way that the slide initially remains in the position in which the switching element is actuated. Alternatively, a return mechanism, in particular, is present, which has, in particular, a spring, and the slide is preferably spring-loaded with the aid of the spring. The slide is again returned to the original position with the aid of the return mechanism after the actuation of the switching element. The slide is thus always situated in the same position, and the circuit breaker always has the same behavior.

The first limit value corresponds, in particular, to a multiple of a nominal current of the circuit breaker, so that the corresponding actuation of the switching element takes place only in the case of a malfunction of the circuit protected with the aid of the circuit breaker. In particular, the first limit value is between three times and four times the nominal current. A corresponding change in the supply of current to the electrical drive thus takes place, in particular, in the presence of an overcurrent. However, the slide is not moved in the case of comparatively small fluctuations around the nominal current, or at least the switching element is not actuated. The first limit value is, in particular, greater than 500 A and suitably less than 1,000 A. In particular, the first limit value is 650 A, 700 A, 750 A, or 800 A.

For example, the busbar can be essentially straight, which makes a manufacturing easier. However, the busbar is particularly preferably essentially L-shaped or C-shaped, the fixed contact being connected to a leg, with the aid of which a free end is formed. The fixed contact is advantageously situated on the outwardly facing side of the leg, i.e., not on the side facing the other leg. The leg of the busbar, to which the fixed contact is connected, is advantageously in parallel to the contact bridge, which is advantageously provided with linear design. A construction is simplified due to a design of this type.

For example, the switching element can be a semiconductor switch or a relay. The switching element is particularly preferably a mechanical switching contact and, for example, a microswitch. As a result, the space requirement and manufacturing costs are reduced. In addition, the mechanical switching contact is comparatively resistant to an arc formed therein when the mechanical switching contact is actuated, in particular opened. A safe actuation of the switching element is thus made possible and therefore a corresponding operation of the electrical drive. An actuation is also made easier in this way. For example, the mechanical switching contact comprises a lever, which is, for example, spring-loaded and acts upon the slide. In particular, the supply of current to the electrical drive is ended/interrupted with the aid of the switching element, in particular, during the actuation of the mechanical switching contact. Due to a possible arc forming in the mechanical switching contact, a comparatively rapid de-excitation of a possible inductor of the electrical drive takes place, in particular of the possible drive coil, so that a force is essentially immediately no longer applied to the contact bridge with the aid of the electrical drive, at least none on the basis of which the moving contact is held at the fixed contact. In summary, a de-excitation of the electrical drive, in particular, takes place via the mechanical switching contact, namely with the aid of the arc which may have formed therein.

For example, the switching element can be provided with a bistable design, so that it remains in this (switching) state after being actuated with the aid of the slide. Only if a further corresponding actuation takes place is the switching element returned again to the original state, advantageously closed. Alternatively, the switching element is provided, for example, with a monostable design. For example, the mechanical switching contact is opened in a monostable manner. However, the mechanical switching contact is particularly preferably closed in a monostable manner. The mechanical switching contact is thus in the electrically conductive state, as long as it is not actuated with the aid of the slide. If the actuation of the switching element with the aid of the slide is thus ended, the switching element is returned again to the electrically conductive state. The return mechanism for the slide is advantageously present. After the switching element has been actuated with the aid of the slide, the slide as well as the switching element are thus placed in the original state in each case, for example, due to a particular spring loading.

Due to the actuation of the switching element and the corresponding change in the supply of current to the electrical drive, in particular, the termination of the supply of current, the contact bridge is preferably moved in such a way that the moving contact is moved away from the fixed contact. The switching element as well as the slide are then also advantageously placed into the original state in each case. For example, a supply of current to the electric drive takes place again, and the contact bridge is moved in such a way that the moving contact again rests against the fixed contact. A formation of an electrical current via the busbar is thus again possible. If the latter again increases above the first limit value, the switching element is again actuated with the aid of the slide. If the electrical current remains below the first limit value, however, the circuit breaker remains in the electrically conductive state. In an example, it is possible, in particular, to operate the electrical drive differently, for which purpose, in particular, a different level of an electrical voltage is applied thereto.

For example, the circuit breaker can be formed without any control unit and thus does not have a control unit. In other words, the circuit breaker is advantageously provided with an electromechanical design and, in particular, does not have a microcontroller and/or electronics. A robustness is thus increased, manufacturing costs being reduced. The circuit breaker advantageous has an auxiliary connection, via which a supply of current to the electrical drive takes place. It is thus possible to place the circuit breaker in the electrically conductive state by applying an electrical voltage to the auxiliary connection. The auxiliary connection advantageously provides the possibility of applying two different electrical voltages to the electrical drive. When using the one electrical voltage, the resulting current supply is sufficient, for example, only to compensate for the force provided by the possible springs, so that it is possible only to leave the circuit breaker in the present (switching) state. However, the use of the other electrical voltage effectuates a compression of the spring, so that the circuit breaker is placed, in particular, in the electrically conductive state.

Alternatively, the circuit breaker can have a control unit. A second switching element is actuated with the aid thereof, and the second switching element and the control unit are suitably connected to each other for this purpose. The second switching element is, for example, a relay or designed as a semiconductor switch. The second switching element is electrically connected in series to the switching element. It is possible that the electrical drive is arranged, for example, between the two switching elements, or one of the two switching elements is arranged between the other switching element and the electrical drive.

The control unit can be designed in such a way that the second switching element is actuated with the aid thereof when the electrical current conducted via the busbar exceeds a second limit value. The circuit breaker advantageously comprises a sensor, with the aid of which the electrical current conducted via the busbar may be detected. The sensor is, in particular, a current sensor, which comprises, for example, a Hall sensor. Alternatively, the sensor comprises a shunt. The control unit is built, for example, discretely, in particular from electrical components, such as capacitors, inductors, and/or resistors. Alternatively, the control unit comprises, for example, an electronic component, in particular a microcontroller. In particular, an ability to adapt the circuit breaker to present circumstances is made possible in this way.

The second limit value can be less than or equal to the first limit value, and the mechanical switching contact is designed to be closed in a monostable manner. For example, the second limit value is between 1.5 times and 2.5 times the nominal current, in particular twice thereof. Alternatively, the second limit value is equal to the first limit value. If the electrical current thus exceeds the second limit value, which is selected to be less than the first limit value, the second switching element is actuated with the aid of the control unit, so that the supply of current to the electrical drive is changed. This advantageously takes place in such a way that the moving contact is moved away from the fixed contact. The slide, however, remains in the original position. Since an evaluation of the measurement data generated with the aid of the sensor is necessary, a time period between the exceeding of the second limit value and the change in the supply of current to the electrical drive is comparatively long. However, since this takes place only with a slightly elevated electrical current, a damage to the circuit is essentially ruled out, the circuit breaker being used for the protection thereof. However, since a comparatively high acceleration of the slide does not occur, a mechanical loading of the circuit breaker is reduced. On the other hand, if the electrical current rises comparatively rapidly and exceeds the first limit value before the second switching element has been actuated, the switching element is actuated with the aid of the slide, so that, in particular, the supply of current to the electrical drive is interrupted. The actuation of the second switching element takes place thereafter in time with the aid of the control unit, with the aid of which, in particular, an electrical current is then no longer conducted, so that the switching takes place essentially load-free.

Since the switching element can be actuated comparatively rapidly with the aid of the slide in the case of an elevated electrical current flow which may result in an endangerment if it last a longer time, namely when exceeding the first limit value, it is possible to use a second switching element having a reduced switching speed. The manufacturing costs are thus reduced without limiting safety.

The switching element can be advantageously designed to be closed in a monostable manner, and the return mechanism for the slide is present, so that the slide is returned again to the original position after the actuation of the switching element, which results in a closing of the switching element. However, since the second switching element was opened with the aid of the control unit, a change in the supply of current to the electrical drive does not take place. Nevertheless, the contact bridge is thus held, in particular, in the position/placed therein, in which the fixed contact is situated at a distance from the moving contact. If the second limit value is selected to be equal to the first limit value, when it is exceeded, the circuit breaker thus also remains in the opened state.

One or multiple further sensors can also be present, depending on whose measurement data or detected states the second switching element is actuated with the aid of the control unit. For example, the second switching element is actuated if high-frequency interference occurs in the electrical current and/or if there is a change of the present electrical voltage, so that, in particular, a supply of current to the circuit in which the circuit breaker is introduced is interrupted.

The slide can be spring-loaded, for which purpose, in particular, a spring is supported thereon. The spring is advantageously a constituent part of the possible return mechanism. The spring is compressed, in particular, when the slide is moved for actuating the switching element. The spring is designed, in particular, as a helical spring. Alternatively, the return mechanism is implemented, in particular, with the aid of the switching element itself, which is provided, in particular, with a monostable design. The force applied to the slide with the aid of the switching element is then advantageously at least partially compensated for with the aid of the spring. The mechanical force to be applied to the switching element by the slide for the purpose of actuating it is thus reduced with the aid of the spring.

For example, the force applied with the aid of the spring is permanently predefined. However, the active force is particularly preferably set with the aid of an adjustment screw, which is also referred to as an adjusting screw. The active force is advantageously functionally associated with the first limit value, so that the first limit value is set with the aid of the adjustment screw. To reduce the first limit value, the active force is decreased, provided that the spring is to be compressed when moving the slide to the switching element. Otherwise, the force is increased. Due to the adjustment screw, it is thus possible to set and/or to calibrate the circuit breaker to the desired application after manufacturing. It is also possible to carry this out in the mounted state of the circuit breaker and/or to compensate for possible aging effects. In particular, no other change to the mechanical components and/or the electronics of the circuit breaker is necessary for this purpose. The adjustment screw advantageously protrudes through the possible housing, and/or the housing has an opening through which the adjustment screw may be reached. It is thus possible to set the first limit value without opening the housing.

For example, it is possible to essentially freely move the switching element after the actuation thereof by the slide. The circuit breaker advantageously comprises the return mechanism, so that the slide is returned again to the original position after the actuation of the switching element. However, the circuit breaker particularly preferably has a restart lockout, which has a first latching element provided with the aid of the slide and a second latching element, which is fixed in relation to the switching element. In other words, the first latching element is, in particular, a constituent part of the slide, while the second latching element is held in a stationary manner in relation to the switching element and is provided, for example, with the aid of the possible housing. In particular, at least one of the two latching elements is designed as an undercut and the other as a spring. Alternatively or in combination therewith, one of the latching elements is designed as a latching hook and the other as a latching tab.

The restart lockout can be designed in such a way that the two latching elements are latched after a movement of the slide due to an electrical current conducted via the busbar, which is higher than a third limit value. The movement takes place, in particular, due to the magnetic interaction between the armature and the yoke. The movement has, for example, already been completed, so that the actuation takes place only afterwards, followed by the latching. Alternatively, the slide continues to be moved after the latching due to the magnetic interaction, so that the latching already takes place before the actuation of the switching element. In this case, the latching is such that, in particular, a further movement of the slide in the direction of the switching element is made possible, so that the switching element may be actuated. However, a complete return of the slide into the original position is prevented. The switching element is advantageously actuated with the aid of the slide when the two latching elements are latched. The switching element is thus held in the actuated position due to the restart lockout.

For example, the third limit value can be equal to the first limit value, so that the restart lockout is used for essentially each actuation of the switching element with the aid of the slide. However, the third limit value is particularly preferably greater than the first limit value and corresponds, for example, to between eight times and ten times the nominal current of the circuit breaker. The restart lockout is thus actuated only in the case of a serious fault in the circuit. An unwanted transfer of the circuit breaker into the conductive state is safely prevented due to the restart lockout. The third limit value is preferably between 1,500 A and 2,000 A.

In particular, the restart lockout can be designed in such a way that it may be deactivated only when the housing is open. In particular, a replacement or removal of the circuit breaker is thus first necessary. This ensures that a user does not reuse the faulty circuit until after a troubleshooting. It is also possible to check whether a damage to the circuit breaker took place due to the elevated electrical current on the basis of the opened housing.

The yoke preferably has the opening. The yoke can be provided, for example, with a U-shaped design, and the busbar is partially encompassed thereby. For example, the armature comes into direct mechanical contact with the yoke during the movement of the slide. However, the armature preferably remains at a distance from the yoke essentially in each position of the slide. The shape of the armature advantageously corresponds to the shape of the opening.

In particular, they are congruent or at least have the same geometric shape. The armature and the opening are, for example, rectangular. However, the opening and the armature are particularly preferably wedge-shaped or triangular, their sizes, in particular, corresponding to each other. The yoke preferably has the size of the opening. Due to the wedge shape, it is possible to comparatively precisely set the magnetic interaction, in particular, the force active between the armature and the yoke. In particular, it is possible to influence a reluctance and thus the level of the active force. It is consequently possible to select the speed at which the slide is moved after the first limit value is exceeded by the conducted electrical current.

For example, the contact bridge can be rotationally supported, so that it is rotated to move the moving contact away from the fixed contact. However, the contact bridge is particularly preferably supported in a longitudinally displaceable manner. A construction is thus simplified. In particular, the support used for this purpose is a friction bearing. For example, the slide is rotationally supported. However, it is particularly preferably supported in a longitudinally displaceable manner, for which reason a support is simplified. For example, the slide is supported essentially perpendicularly to the contact bridge, which is also longitudinally displaceable. In particular, a comparatively efficient utilization of installation space is thus made possible. The slide is advantageously designed in such a way that it is moved between the moving contact and the fixed contact, for example, after the switching element was actuated. The mechanical separation of the two contacts is thus ensured with the aid of the slide and, if an arc is present therebetween, an increase in the electrical voltage necessary for maintenance takes place with the aid of the slide. In addition, an electrical sparkover between the moving contact and the fixed contact is subsequently prevented. Its isolating effect is thus improved. Alternatively or in combination therewith, the slide is used as a restart lockout and, in particular, to prevent an unintentional placement of the moving contact against the fixed contact.

However, the contact bridge and the slide can be particularly preferably supported in parallel to each other. It is thus possible to coordinate their two supports with each other and, for example, to use a portion of the support of the contact bridge for the support of the slide, which increases a compactness and, in particular, reduces manufacturing costs. The support is particularly preferably such that the slide mechanically strikes a coupling rod connected to the contact bridge during a movement of the slide, due to an electrical current conducted via the busbar which is higher than a fourth limit value. The movement takes place, in particular, due to the magnetic interaction between the armature and the yoke. For example, the slide strikes the coupling rod indirectly or advantageously directly. The contact bridge is fastened, for example, directly to the coupling rod, or the possible contact bridge carrier is advantageously rigidly fastened to the coupling rod.

Due to the striking of the coupling rod, a force can be applied to the contact bridge, which is directed away from the fixed contact. In particular, the force is moved in parallel to the direction in which the contact bridge is supported and in the direction for moving the moving contact away from the fixed contact. In other words, the force is directed, in particular, in parallel to an opening direction of the contact bridge. In other words, a force is applied to the contact bridge, in particular with the aid of the slide, in such a way that the moving contact is moved away from the fixed contact. The slide acts, in particular, in the manner of an impact armature. The force is thus additionally applied to the contact bridge due to the slide, so that an accelerated movement of the moving contact away from the fixed contact takes place. In summary, the circuit breaker is thus designed in such a way that the force is applied to the contact bridge with the aid of the slide if the conducted electrical current is higher than the fourth limit value.

The fourth limit value can be, for example, equal to or advantageously greater than the first limit value. In particular, the fourth limit value is equal to the possible third limit value and/or between five times and ten times the nominal current of the circuit breaker. In particular, the fourth limit value is between 2,000 A and 7,000 A and preferably between 3,000 A and 4,000 A. The striking of the coupling rod thus takes place only in the case of a comparatively high electrical current, while this is prevented in the case of lower electrical currents, and the contact bridge is advantageously moved only with the aid of the electrical drive. A loading of the slide is thus reduced.

For example, the application of the force can take place when the movement of the slide has ended or, for example, the movement is ended with the aid of the application. For example, the application of the force takes place simultaneously with the actuation of the switching element. The circuit breaker is advantageously designed accordingly for this purpose. However, the contact bridge and the slide are particularly preferably supported in parallel to each other in such a way, and/or the circuit breaker is designed in such a way, that the slide mechanically strikes the coupling rod only after the switching element has been actuated. The actuation of the switching element is thus not delayed due to the application of force to the coupling rod. In other words, it is ensured with the aid of the time-shifted striking of the coupling shaft that the actuation of the switching element is not delayed, so that the electrical drive is actuated comparatively quickly and operated accordingly. The operation of the electrical drive which is changed in this way is supported with the aid of the striking of the coupling rod. In addition, the kinetic energy of the slide is decreased in this way without a damage occurring thereto.

For example, a Litz wire or another movable/flexible electrically conductive component, which is electrically contacted to the possible remaining connection, can be connected to the contact bridge. However, the circuit breaker particularly preferably comprises a further busbar, to which a further fixed contact is connected. The further busbar is electrically contacted, in particular, to the remaining connection, so that, in each case, one of the two busbars is electrically contacted, in particular, to each of the two connections, advantageously in a rigid and/or direct manner. In particular, a further moving contact is connected to the contact bridge. During the movement of the contact bridge, in particular, the moving contact is mechanically placed against or separated from the fixed contact and the further moving contact is mechanically placed against or separated from the further fixed contact. When moved away from each other, they are advantageously essentially separated from each other simultaneously. In this way, a double interruption of the electrical current flow takes place when the contact bridge is moved away, so that it is possible to switch even comparatively high electrical voltages with the aid of the circuit breaker. An electrical voltage is doubled, which is necessary to maintain an electrical current flow, due to forming arcs.

In particular, a further arc chute can be assigned to the further fixed contact and the further moving contact. It is advantageously of the same design as the possible arc chute. The busbars and the contacts are each suitably of the same design, so that equivalent parts may be used. The busbars are advantageously arranged in a mirror-inverted manner in relation to each other, and the busbar and the further busbar are provided with a C-shaped design, so that a comparatively efficient utilization of the installation space may take place. In particular, the legs, which carry the fixed contacts, face away from each other and are suitably situated on a shared straight line. The contact bridge is advantageously essentially linear, which simplifies a construction.

For example, only the yoke is present. However, a further yoke can be placed around the further busbar, which is advantageously of the same design as the yoke. A further armature, which is, in particular, of the same design as the armature, is advantageously connected to the slide, for which reason equivalent parts may be used. The further yoke and the further armature are designed, in particular, in such a way that the slide is moved due to a magnetic interaction therebetween. In other words, the slide is also moved between the further yoke and the further armature, due to the magnetic interaction, when the electrical current exceeds the first limit value or another of the possible limit values. The force acting upon the slide is thus increased due to the further yoke and the further armature, for which reason an acceleration is increased thereby. It is also possible to dimension the two yokes and the two armatures to be smaller, a safe movement of the slide nevertheless occurring upon exceeding the particular limit value.

The circuit breaker advantageously can have a switch unit, which comprises the busbar, the fixed contact, the contact bridge, and the moving contact. If the further busbar and the further fixed contact and the further moving contact are present, they are also assigned to the switch unit. In particular, the switch unit comprises the two possible connections as well as the possible current path formed therebetween. The circuit breaker suitably has a second busbar, to which a second fixed contact is connected. The circuit breaker also comprises a second contact bridge, to which a second moving contact is connected. The second busbar, the second contact bridge, the second fixed contact, and the second moving contact are of the same design as the busbar, the contact bridge, the fixed contact, and the moving contact, respectively. In particular, the second busbar and the second contact bridge are a constituent part of a second switch unit, which is advantageously of the same design as the switch unit.

The two contact bridges can be connected to the possible contact bridge carrier, which is advantageously manufactured from a plastic. In particular, the contact bridge carrier is driven with the aid of the electrical drive, and the two contact bridges are driven via the contact bridge carrier. In other words, the two contact bridges are assigned to the (same) electrical drive. In the case of the two switch units, the electrical current flow is thus essentially generated and interrupted synchronously.

A second yoke is suitably placed around the second busbar. it is designed/arranged in such a way, for example, that it also has a magnetic interaction with the armature, based on which, in particular, a corresponding movement of the slide takes place. However, a second armature, which is suitably of the same design as the armature, is particularly preferably connected to the slide. Due to a design of this type, it is thus possible to interrupt the current flow in two separate circuits simultaneously if the electrical current in one of the circuits is higher than the particular limit value. In summary, the slide is moved when the conducted electrical current in one of the two busbars is higher than the (particular) first limit value, in particular due to the particular magnetic interaction, so that the switching element is actuated. It is also possible, for example, to introduce the circuit breaker into a forward conductor as well as a return conductor for a load, a safety therefore being increased. In this case, the necessary force active between the particular yoke and the particular armature is reduced which results in a movement of the slide, thereby simplifying a construction.

The circuit breaker can be particularly preferably used to interrupt direct voltage and/or direct current. The circuit breaker is advantageously used in a motor vehicle or an industrial plant. The invention also relates to a corresponding use of the circuit breaker. The invention further relates to a circuit, which has a circuit breaker of this type. The circuit advantageously has a DC voltage source as well as a load. In particular, the circuit is a constituent part of a motor vehicle. The DC voltage source is, for example, an energy store, such as a high-voltage battery, and the load is, for example, an electric motor or at least a drive comprising the electric motor.

The refinements and advantages explained in connection with the circuit breaker are to be similarly transferred to the use/the circuit as well as to each other and vice versa.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 schematically shows a DC circuit comprising a circuit breaker which has two switch units;

FIG. 2 shows a perspective view of the circuit breaker;

FIG. 3 shows a perspective view of the circuit breaker, a housing being omitted;

FIGS. 4 and 5 each show a detail of one of the switch units from different perspectives;

FIG. 6 shows a perspective view of a slide of the circuit breaker;

FIG. 7 shows a perspective view of the switch unit;

FIGS. 8 through 10 each show the circuit breaker in a vertical and a horizontal sectional representation, respectively, of the circuit breaker;

FIG. 11 shows a detail of the circuit breaker, which has a restart lockout, in a sectional representation;

FIG. 12 shows a perspective view of a further example of the circuit breaker;

FIG. 13 shows a perspective view of the circuit breaker according to Figure 12, the housing being omitted;

FIGS. 14 and 15 each show a detail of one of the switch units of the circuit breaker according to FIG. 12 from different perspectives;

FIG. 16 shows a perspective view of a slide of the circuit breaker according to FIG. 12; and

FIGS. 17 and 18 show a perspective view and a rear view, respectively, of one of the switch units of the circuit breaker according to FIG. 12.

### DETAILED DESCRIPTION

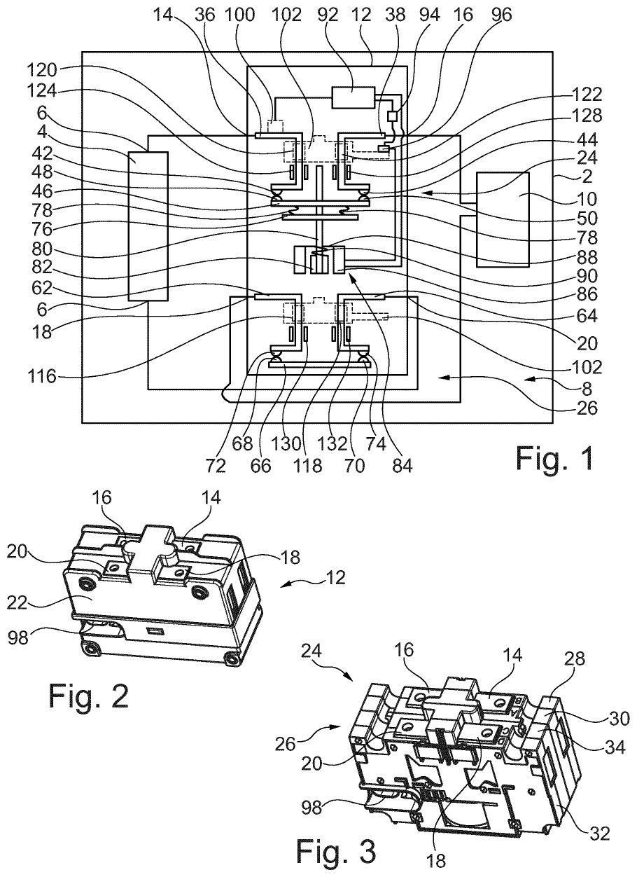

FIG. 1 schematically shows a motor vehicle 2 in the form of a truck. Motor vehicle 2 includes an energy store 4 with two poles 6. An electrical DC voltage having a level of 1,000 V is present between the two poles 6. A vehicle electrical system 8 of motor vehicle 2 is supplied with the aid of energy store 4 and is thus a high-voltage vehicle electrical system. A drive 10 of motor vehicle 2, which represents the main drive of motor vehicle 2, is connected to vehicle electrical system 8. In other words, wheels of motor vehicle 2, which are not illustrated in greater detail, are driven with the aid of drive 10, so that a locomotion of motor vehicle 2 takes place. Drive 10 has an electric motor, which is not illustrated in greater detail, and a converter for this purpose.

A circuit breaker 12 is present to protect vehicle electrical system 8 and drive 10, which is illustrated perspectively in FIG. 2. Circuit breaker 12 is electrically connected between energy store 4 and vehicle electrical system 8. It is possible to change the switching state of circuit breaker 12, so that it is either conductive (closed) or electrically non-conductive (open). During a normal operation, an electrical current of up to 500 A is conducted via circuit breaker 12. In other words, the nominal current of circuit breaker 12 is equal to 500 A.

Circuit breaker 12 has a connection 14, which is connected to the one pole 6 of energy store 4. A further connection 16, which has the same electrical potential as connection 14 as long as circuit breaker 12 is in the electrically conductive state, is run against vehicle electrical system 8. A second connection 18 of circuit breaker 12 is also contacted with vehicle electrical system 8, and a second further connection 20 is electrically contacted with remaining pole 6 of energy store 4. Second connection 18 and second further connection 20 also have the same electrical potential, provided that circuit breaker 12 is in the electrically conductive state. The direction of the electrical current between connection 14 and further connection 16 also corresponds to the direction of the electrical current between second connection 18 and second further connection 20. Connections 14, 16, 18, 20 protrude through a housing 22, which is made from a plastic. Housing 22 is provided with a multi-part design, for which reason a manufacturing of circuit breaker 12 is made easier.

Arranged within housing 22 are the remaining constituent parts of circuit breaker 12, which has a switch unit 24 and a second switch unit 26, which are essentially provided with a similar design, namely, in particular, a mirror-image design. Switch unit 24 has a housing shell 28 and a further housing shell 30, which are placed against each other, as illustrated in FIG. 3. The second switch unit has a second housing shell 32 and a second further housing shell 34, which are constructed and arranged in a mirror-image manner relative to housing shells 28, 30 of switch unit 24. Second further housing shell 34 rests against further housing shell 30, and the outsides of housing shells 28, 30, 32, 34 are arranged to be flush with each other.

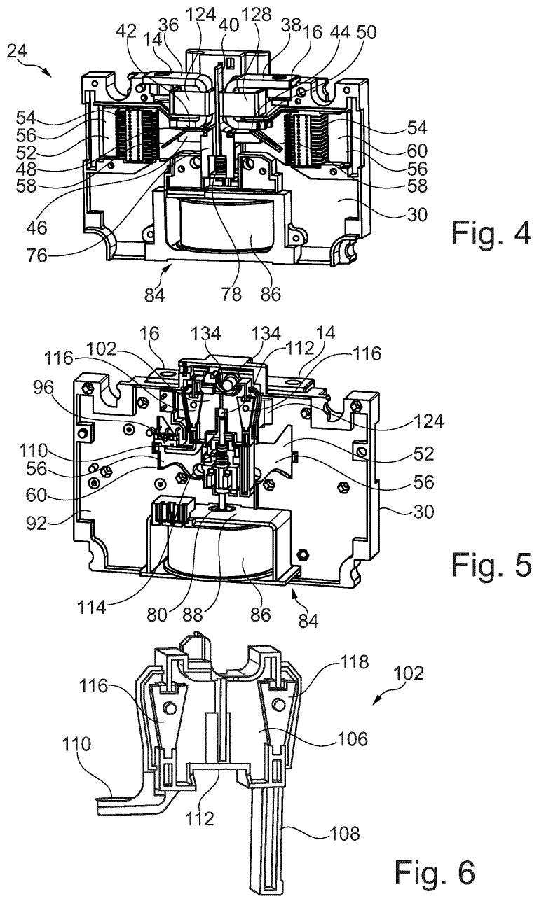

FIG. 4 shows a perspective view of switch unit 24 from one side, and FIG. 5 shows it from the opposite side, housing shell 28 not being illustrated. Switch unit 24 has a busbar 36, which is a copper part bent in the shape of a C. Connection 14 is formed with the aid of one of the two parallel legs of busbar 36. Switch unit 24 has a further busbar 38, which is provided with a mirror-image design relative to busbar 36 and with the aid of which further connection 16 is formed. Each of the two inner legs of C-shaped busbars 36, 38 are arranged in parallel to each other and are offset from each other. To avoid an electrical short-circuit, an insulating plate 40 arranged therebetween and made from a plastic is arranged therebetween and formed on further housing shell 30.

The legs of the two busbars 36, 38 having particular connection 14, 16 are also arranged in parallel to each other while facing away from each other. A fixed contact is connected to the remaining leg of busbar 36, and a further fixed contact 44 is connected to the remaining leg of further busbar 38. Fixed contacts 42, 44 are situated on the side of particular busbar 36, 38 facing away from particular connection 14, 16.

Switch unit 24 also has a contact bridge 46, which is movably supported. It is possible to place contact bridge 46 in parallel to the middle legs of each C-shaped busbar 36, 38. Contact bridge 46 is a copper strip and is arranged in parallel to the end-side legs of busbars 36, 38. A moving contact 48 and a further moving contact 50 are connected to contact bridge 46. Moving contacts 48, 50 are situated on the sides of contact bridge 46 facing busbars 36, 38.

A mobility of contact bridge 46 is limited with the aid of fixed contacts 42, 44, namely when moving contact 48 rests against fixed contact 42 and further moving contact 50 rests against further fixed contact 44. In this position of contact bridge 46, the two connections 14, 46 are electrically connected to each other in a low-resistance manner. During a movement of contact bridge 46 in parallel to the course of the middle one of the legs of the two busbar 36, 38 in each case, moving contacts 48, 50 are moved away from assigned fixed contacts 42, 44, so that the electrical connection of the two connections 14, 16 is released. The two connections 14, 16 are also then galvanically isolated from each other.

Switch unit 24 furthermore has an arc chute 52, including an extinguishing element 54, which is formed from multiple arc splitters stacked one on top of the other. Extinguishing element 54 is arranged within a magnetic yoke 56, which is formed with the aid of multiple soft iron plates, which are partially illustrated. To deflect a possible arc emerging between fixed contact 42 and moving contact 48, a guide plate 58 is fastened to contact bridge 46, which is inclined in relation to the course of contact bridge 46. A further arc chute 60 is assigned to further fixed contact 44 and further moving contact 50, which is of the same design as arc chute 52 and which thus also has extinguishing element 54, magnetic yoke 56, and guide plate 58. The two arc chutes 52, 60 are arranged in each case on the open side of assigned C-shaped busbar 36, 38.

Second switch unit 26 is constructed in the same manner as first switch unit 24 and has a second busbar 62, which has a design corresponding to busbar 36. Switch unit 26 also has a second further busbar 64 and a second contact bridge 66. A second moving contact 68 and a second further moving contact 70 are connected to second contact bridge 66, which may be brought into mechanical contact with a second fixed contact 72 and a second further fixed contact 74, respectively, which are fastened to second busbar 62 and second further busbar 64, respectively.

The two contact bridges 46, 66 are connected to a shared contact bridge carrier 76 and are supported thereon such that they are movable to a limited degree. Contact bridge carrier 76 has corresponding stops for this purpose, between which contact bridges 46, 66 may be moved, and each contact bridge 46, 66 is supported on contact bridge carrier 76 with the aid of a spring 78 in each case. Springs 78 are tensioned when moving contacts 48, 50, 68, 70 rest against assigned fixed contacts 42, 44, 72, 74 in each case. In this variant, contact bridge carrier 76 is made from a plastic and is assembled from multiple parts, namely three parts. In one variant, which is not illustrated in greater detail, contact bridge carrier 76 forms a single piece. In another refinement, insulating plate 40 is connected to, in particular formed on, contact bridge carrier 76, regardless of the specific design thereof, and not on further housing shell 30.

Contact bridge carrier 76 is rigidly connected to a coupling rod 80, which is supported in a longitudinally movable manner. Coupling rod 80 is fastened on the end side to a coil armature 82 of an electrical drive 84. The latter has a drive coil 86, which is an electrical coil, and coupling rod 82 is situated on the axis of drive coil 86. The end face of drive coil 86 facing contact bridge carrier 76 is covered by a magnetic shorting plate 88, through which coupling rod 80 protrudes. Coil armature 82 is supported on shorting plate 88 with the aid of a spring 90 of electrical drive 84, spring 90 being compressed and thus tensioned when coil armature 82 is situated essentially within drive coil 86. In this case, contact bridge carrier 76 is in a position such that the two contact bridges 46, 66 connected thereto are connected to particular connections 14, 16, 18, 20 in an electrically conductive manner. However, spring 90 is relaxed when coil armature 82 is situated at least partially outside drive coil 86.

In this case, contact bridges 46, 66 are situated at a distance from busbars 36, 38, 62, 64 assigned in each case, and contact bridge 12 is in the electrically non-conductive state. Electrical drive 84 is thus assigned to the two switch units 24, 26, and the latter are actuated thereby.

The supply of current to electrical drive 84 takes place with the aid of a control unit 92, which comprises a printed circuit board as well as electrical and/or electronic components connected thereto, which are not illustrated in greater detail. Control unit 92 is connected to electrical drive 84, namely drive coil 86, via a second switching element 94, which is actuated with the aid of control unit 92, and a switching element 96, which are electrically connected in series. In summary, switching element 96 and second switching element 94 are electrically connected in series to each other and to electrical drive 84.

Second switching element 94 is a semiconductor switch, such as a MOSFET, and switching element 96 is a mechanical switching contact, i.e., a mechanical switch. The mechanical switching contact is provided with a monostable design and is opened or closed in a monostable manner. If the mechanical switching contact has the non-stable state in each case, and no other limitations are present and/or no other forces are active, the mechanical switching contact is transferred into the stable state, due to the design, i.e., it is opened or closed.

The supply of current to control unit 92 takes place via an auxiliary connection 98, to which a low-voltage vehicle electrical system is connected in the mounted state and with the aid of which an electrical DC voltage of 24 V is conducted. Electrical drive 84 is thus operated with 24 V. A signaling connection also takes place via auxiliary connection 98, using an on-board computer of motor vehicle 2, which is not illustrated in greater detail, with the aid of which control unit 92 is thus operated or may be induced to have a certain behavior. It is also possible to request a switching state of circuit breaker 12 via auxiliary connection 98. Circuit breaker 12 furthermore comprises a sensor 100, with the aid of which the electrical current conducted via busbar 36 may be detected. For this purpose, sensor 100 is designed, for example, as a Hall sensor or as a shunt.

Circuit-breaker 12 also has a slide 102, which is illustrated perspectively in FIG. 6. Slide 102 is manufactured as a single piece and from plastic. Slide 102 has a body 106, to which a bearing rod 108 is connected, Bearing rod 108 is guided in a guide of housing shells 28, 30, which is not illustrated in greater detail, so that slide 102 is movably supported. The bearing direction is in parallel to coupling rod 80, so that coupling rod 80, the two contact bridges 46, 66, and slide 102 are movably supported in the same direction, i.e., in parallel to each other.

An actuating element 110 arranged perpendicularly to bearing rod 108 is also connected to body 106. Body 106 has a blind hole-like receiving opening 112 running in parallel to bearing rod 108, within which coupling rod 80 is situated. Slide 102 is supported via a spring 114 on coupling rod 80 on a circumferential bulge-like thickening thereof. In one variant, which is not illustrated in greater detail, spring 114 is supported on one of housing shells 28, 30 instead of on slide 102.

A second armature 116 and a second further armature 118 are fastened to body 106 with the aid of adhesive or a clip connection. An armature 120 and a further armature 122 are fastened to body 106 on the opposite side thereof, which are arranged congruently to second armature 116 and second further armature 118, respectively.

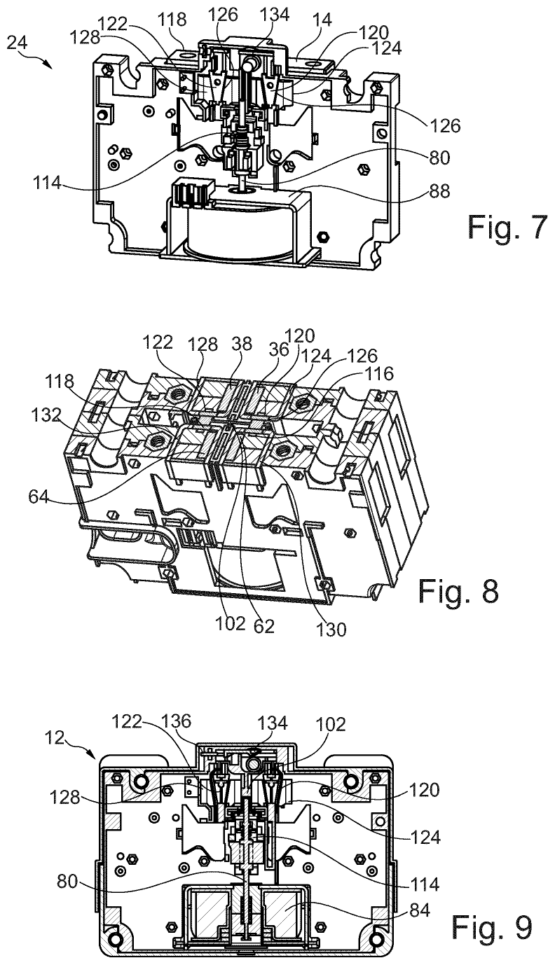

Switch unit 24 according to FIG. 5 is illustrated in FIG. 7, however, slide 102 and second armature 116 as well as second further armature 118 not being illustrated, which are arranged congruently to armature 120 and further armature 122. All armatures 116, 118, 120, 122 are of the same design and are each made from soft iron. They are also provided with an essentially wedge-shaped design, are arranged in parallel to coupling rod 80, and the particular tip points in the direction of electrical drive 84.

Armature 120 is arranged in a yoke 124, which has a wedge-shaped opening 126. The size of opening 126 corresponds to the size of armature 120. Yoke 124 is made from a soft iron and placed around busbar 36. Yoke 124 is essentially annular and opened only by means of opening 126. A further yoke 128 is placed around further busbar 38, which is of the same design as yoke 124 and thus has opening 126.

As illustrated in FIG. 8 in a sectional representation in parallel to contact bridges 46, 66, a second yoke 130, which is assigned to second armature 116, is placed around second busbar 82. A second further yoke 132, which is assigned to second further armature 118, is placed around second further busbar 64. All yokes 124, 128, 130, 132 are of the same design and each have corresponding opening 126, which is provided with a wedge-shaped design and corresponds to assigned armature 116, 118, 120, 122 in each case, which are also of the same design.

If an electrical current is to be conducted with the aid of circuit breaker 12, i.e., in particular, if vehicle electrical system 8 is to be operated, second switching element 94 is closed with the aid of control unit 92. Due to the support of slide 102 on coupling rod 80 with the aid of spring 114, the latter is situated on a stop of its possible adjustment path. In this position, actuating element 110 rests against switching element 96, and the latter is in the electrically conductive state. Switching element 96 is designed to be open in a monostable manner. As a result, electrical drive 84 is supplied with current, and a magnetic field forms in drive coil 86, for which reason coil armature 82 is moved into drive coils 86 against the force applied with the aid of spring 90. Coupling rod 80 is therefore also moved. Since slide 102 is already at the stop of the adjustment path, a movement away therefrom does not occur. However, spring 114 continues to be tensioned. If spring 114 is supported on one of housing shells 28, 30, it is also tensioned like spring 90. Spring 114 is, for example, shortened compared to spring 90, so that spring 114 is tensioned only in the last part of the movement of coupling rod 80.

Contact bridge carrier 76 is also moved due to the movement of coupling rod 80. Moving contacts 48, 50, 68, 70 are therefore placed against fixed contact 42, 50, 72, 74 assigned in each case. Connection 14 is thus connected to further connection 16 in a low-resistance manner, and second connection 18 is connected to second further connection 20 in a low-resistance manner. As a result, the electrical current flows over circuit breaker 12, namely over each busbar 36, 38, 62, 64. Due to the particular shape as well as the arrangement thereof, a magnetic field is induced in each yoke 124, 128, 130, 132, or the magnetic field surrounding particular busbar 36, 38, 62, 74 is concentrated therein.

A comparatively high magnetic resistance is present, due to particular opening 126, and the magnetic field lines run partially through assigned armature 116, 118, 120, 122. As a result, a force is applied thereto in the direction of particular openings 126. A force is consequently also applied to slide 102 in the direction of electrical drive 84. At nominal current, however, this force is not sufficient to counteract the counter-force provided with the aid of spring 114, so that a movement of slide 102 does not take place. The slide 102 thus remains in the original position, and switching element 96 is held in the electrically conductive state with the aid of actuating element 110.

If the supply of current to vehicle electrical system 8 is to be ended, second switching element 94 is opened with the aid of control unit 92. As a result, the supply of current to electrical drive 84 is ended. If control unit 92 is provided with a comparatively rudimentary design or is omitted, an electrical voltage is no longer applied, for example, to connection 98, and the supply of current to electrical drive 84 is thus also ended. Only the force provided with the aid of spring 90 and with the aid of spring 114, if the latter are supported on one of housing shells 28, 30, therefore acts upon coil armature 82, so that coil armature 82 is moved out of dive coil 86. Contact bridges 46, 66 are therefore moved, and moving contacts 48, 50, 68, 70 are moved away from fixed contact 42, 50, 72, 74 assigned in each case, which results in a double interruption of the electrical current conducted with the aid of each of contact bridges 46, 66. If an arc forms in this case, it is extinguished with the aid of particular arc chute 52, 60.

If the conducted current increases during the desired supply of current to vehicle electrical system 8, for example due to a fault, this is detected with the aid of sensor 100. If the electrical current exceeds a second limit value corresponding to twice the nominal current, i.e., 400 A, second switching element 94 is actuated with the aid of control unit 92, and the supply of current to electrical drive 84 is thus ended. Circuit breaker 12 is therefore also transferred into the electrically non-conductive state. The existing magnetic forces between each yoke 124, 128, 130, 132 and armature 116, 118, 120, 122 assigned in each case is not yet sufficient in this case to move slide 102. In summary, second switching element 94 is actuated with the aid of control unit 92 when electrical current conducted over busbar 36 exceeds the second limit value.

However, if the conducted electrical current increases comparatively rapidly, it is possible that it exceeds a first limit value which is greater than the second limit value before this has been corrected detected and/or processed with the aid of control unit 92. In this case, the first limit value is 700 A. When the first limit value is exceeded, the magnetic force active between each yoke 124, 128, 130, 132 and assigned armature 116, 118, 120, 122 is sufficient to overcompensate for the counter-force provided with the aid of spring 114, so that slide 102 is accelerated in the direction of electrical drive 84. As a result, actuating element 110 is released from switching element 96, so that the supply of current to electrical drive 84 is interrupted. Moving contacts 48, 50, 68, 70, in turn, are therefore released from fixed contact 42, 50, 72, 74 assigned in each case.

Due to the electrical current, which is now no longer present or is at least reduced, the magnetic interaction also decreases, so that slide 102 is moved back into the original position due to spring 114, so that switching element 96 is actuated and closed. However, the time until this happens is sufficient for second switching element 94 to be actuated with the aid of control unit 92, so that a supply of current to the electrical drive 84 no longer occurs despite closed switching element 96.

If control unit 92 and/or second switching element 94 is/are not present, a supply of current to electrical drive 84 again takes place due to the actuation of switching element 96. The electrical current used is advantageously not sufficient to again move coupling rod 80, in particular, against the spring force of spring 90 and possibly spring 114. In particular, the application of an additional electrical voltage is necessary for this purpose, in particular, via auxiliary connection 98. In other words, in particular, the electrical drive thus has two states, a movement of coupling rod 80 against the spring force being possible in the one state, and only a holding of coupling rod 80 in the present position being made possible in the other state. In particular, the state is predefined via the supply of current to auxiliary connection 98, and the state in which the movement of coupling rod 80 against the spring force is possible is only briefly implemented during the startup of circuit breaker 12. To implement the two different states, drive coil 86 is, for example, divided in two and thus has two electrical coils separate from each other. The number of windings of one of the electrical coils is reduced, and with the aid of the current supply thereto, it is only possible to hold coupling rod 80 in the present position in each case. When supplying current to the other electrical coil of drive coil 86, on the other hand, it is possible to move coupling rod 80 against the force applied with the aid of spring 90.

Circuit-breaker 12 further has a leg spring 134, with the aid of which slide 102 is loaded against the force of spring 114, as illustrated in FIG. 9 in a vertical sectional representation of circuit breaker 12. In other words, a force is applied to slide 102 in the direction of electrical drive 84 with the aid of leg spring 134. The applied force, i.e., the active force, may be set with the aid of an adjustment screw 136 which protrudes through housing 22. It is thus possible to set the active force outside housing 22 with the aid of adjustment screw 136. The force provided by spring 114 is at least partially compensated for by this force, so that the first limit value may be change and adapted to the particular application case by actuating adjustment screw 136. If spring 114 is supported on one of housing shells 28, 30, however, a force directed away from electrical drive 84 is applied with the aid of leg spring 134. It thus corresponds to the force with the aid of which slide 102 is held in the original position and thus at the first limit value. In summary, the slide 102 is spring-loaded, and the active force is set with the aid of adjustment screw 136.

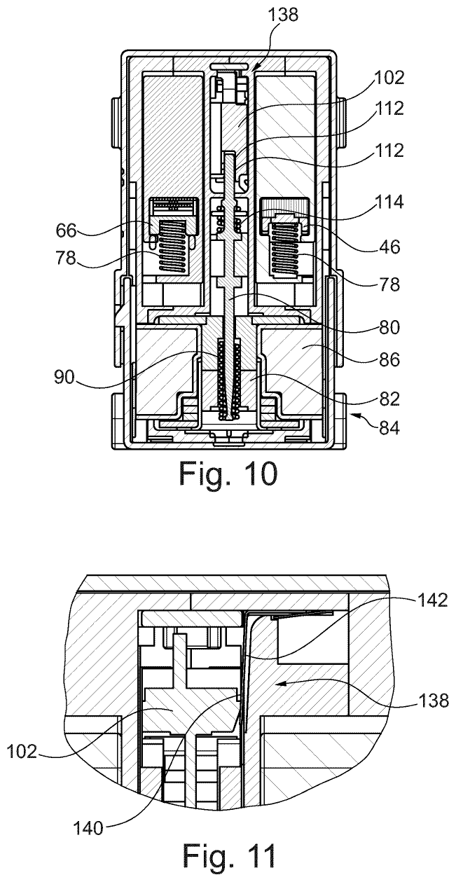

If the electrical current conducted with the aid of busbar 36 during the operation of circuit breaker 12 exceeds a fourth limit value which is greater than the first limit value, spring 114 is compressed to a comparatively great degree, and the base of blind hole-like receiving opening 112 illustrated in FIG. 10 in a sectional representation of circuit breaker 12 strikes the end of coupling rod 80, so that a force is additionally applied thereto with the aid of slide 102. Therefore, after the supply of current to drive coil 86 is interrupted, a force is applied to coupling rod 80 not only with the aid of spring 90, but also with the aid of slide 102, which results in an accelerated movement of the two contact bridges 46, 66. The depth of receiving opening 112 is sufficiently great, so that the application takes place only after switching element 96 has been actuated.

In summary, contact bridge 46 and slide 102 are supported in parallel to each other in such a way that, during the movement of slide 102, slide 102 mechanically strikes coupling rod 80 to which contact bridge 46 is connected, due to the current conducted via busbar 36, which is higher than the fourth limit value. The fourth limit value is greater than the first limit value and is 4,000 A in this example. Due to the striking, a force is applied to coupling rod 80, and thus also to contact bridge 46, which is directed away from fixed contact 42. Slide 102 mechanically strikes coupling rod 80 only after switching element 96 has been actuated with the aid of slide 102.

Circuit breaker 12 furthermore comprises a restart lockout 138, a detail of which is illustrated in an enlarged view in a sectional representation in FIG. 11. Restart lockout 138 has a first latching element 140, which is provided with the aid of slide 102. It is an undercut of body 106, i.e., in particular, a step. Restart lockout 138 also has a second latching element 142, which is designed as a leaf spring, which is fastened to one of housing shells 28, 30 on an end side, the remaining free end being bent essentially 90°, so that it rests against slide 102, but projects over the undercut on the end side. The free end points in the direction of electrical drive 84. Second latching element 142 is thus fixed in relation to each of the two housing shells 28, 30 and therefore also in relation to switching element 96 fastened thereto.

if slide 102 is moved a comparatively long distance in the direction of electrical drive 84, due to a comparatively high active magnetic force, which occurs when the electrical current exceeds a third limit value, the undercut is guided over the free end of the leaf spring, which engages therewith. The two latching elements 140, 142 are latched thereby. In other words, restart lockout 138 is designed in such a way that the two latching elements 140, 142 are latched after a movement of slide 102, due to an electrical current conducted over busbar 36 which is higher than the third limit value. A movement of slide 102 back into the original position is thus prevented, and switching element 96 remains in the open, i.e. actuated, state. It is thus not possible to again supply current to vehicle electrical system 8 until restart lockout 138 is reset. The third limit value is greater than the first limit value, so that the latching action takes place only in the case of an elevated electrical current. In the illustrated variant, the third limit value is selected to be equal to or less than the fourth limit value. In this case, the third limit value is equal to 3,500 A.

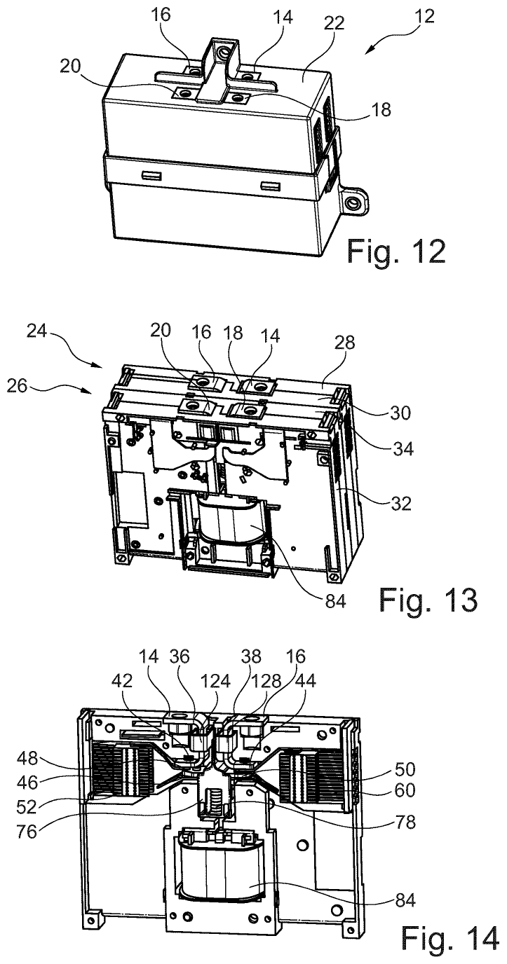

An example of circuit breaker 12 is illustrated in FIG. 12, which also has housing 22. Connections 14, 16 18, 20 are also introduced therein. The auxiliary connection 98, which is not illustrated in greater detail, is present as well.

Furthermore, the two switch units, 24, 26, including housing shells 28, 30, 32, 34, whose geometric dimensions are slightly changed, compared to the preceding example, are arranged in housing 22, as illustrated in a perspective view in FIG. 13. However, they are also still flush with each other on the outside, and their arrangement is unchanged.

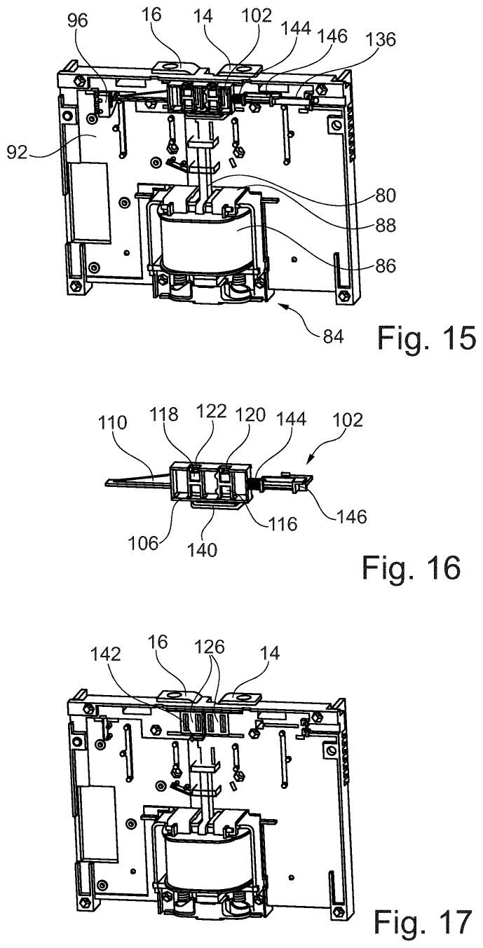

FIG. 14 shows a perspective view of switch unit 24 from one side, and FIG. 15 shows it from the opposite side, housing shell 28 not being illustrated. The design of busbars 36, 38, contact bridge 46, fixed contacts 42, 44, and moving contacts 48, 50 is essentially unchanged. The two arc chutes 52, 60 are also again present. Contact bridge carrier 76 is also not modified, and contact bridge 46 is also again supported thereon with the aid of spring 78. Contact bridge carrier 76 is rigidly fastened to coupling rod 80, which is fastened to electrical drive 84. This construction is slightly changed, the essential components also being present, and their functionality as well as arrangement being essentially unchanged. Control unit 92 is also again present, as are second switching element 94, which is not illustrated in greater detail, and sensor 100.

Slide 102 is also again present, which, in contrast to the preceding example, is supported perpendicularly to coupling rod 80 and not in parallel thereto and is movable in the stack direction of housing shells 28, 30, 32, 34. Slide 102 illustrated in the perspective view in FIG. 16 is also made from plastic and continues to have body 106, to which armatures 116, 118, 120, 122 are fastened. In one variant, second armature 116 and armature 120 are combined into a common component. Likewise, second further armature 118 and further armature 122 are combined into a common component.

Actuating element 110 is designed to taper to a point and extends in the direction in which slide 102 is movably supported. Actuating element 110 is supported on switching element 96, which is closed in a monostable manner and is also designed as a mechanical switching contact. When switching element 96 is closed, a force acting against the mobility of slide 102 is applied with the aid thereof to actuating element 110. In other words, slide 102 is supported on a lever of mechanical switching contact 96, which is spring-loaded and results in an opening of switching element 96 when it is actuated.

An adjustment spring 144, which is supported on a spring bearing 146, is arranged on the side of body 106 opposite actuating element 110. Adjustment spring 144 is a helical spring, and a force is applied with the aid thereof to switching element 96, which, however, does not yet result in an actuation, i.e., in an opening. The position of spring bearing 146 is predefined with the aid of adjustment screw 136. In other words, spring bearing 146 is moved in the direction of slide 102 or moved away therefrom during a rotation of adjustment screw 136, so that a compression of adjustment spring 144 is changed. In other words, the force which slide 102 withholds from the actuation of switching element 96, and thus the first limit value, is set in this way.

Corresponding yoke 124, 128, 130, 132 is again placed around each busbar 36, 38, 62, 64. Opening 126 is rectangular in this variant, as illustrated in FIG. 17, in which slide 102 is not shown, so that each yoke 124, 128, 130, 132 is essentially U-shaped. Armatures 116, 118, 120, 122 re also rectangular. In this case as well, the force active between yokes 124, 128, 130, 132 and assigned armatures 116, 118, 120, 122 is sufficient to press slide 102 against switching element 96 in such a way that the latter is actuated only when the electrical current conducted with the aid of busbar 36 exceeds the first limit value. If the magnetic interaction is no longer present or is reduced, slide 102 is moved into the original position against the force applied with the aid of adjustment spring 144, due to the design of switching element 96, and switching element 96 is opened.

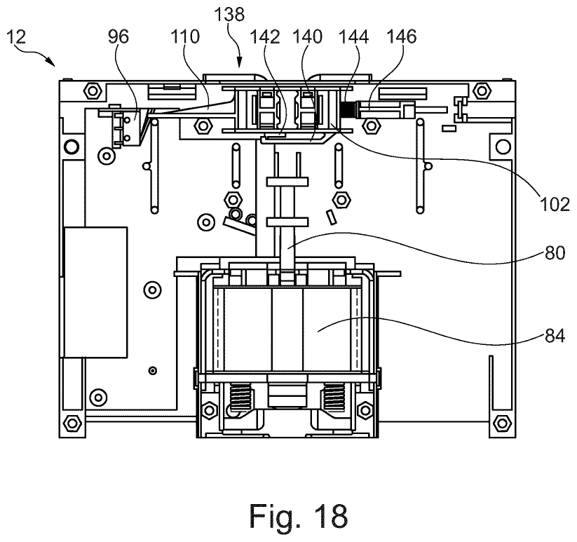

First latching element 140, which is designed as a latching hook, is connected to body 106, as illustrated in FIG. 18 in a sectional representation of circuit breaker 12. When slide 102 has been sufficiently moved in the direction of switching element 96, which takes place when the electrical current conducted with the aid of busbars 36 is higher than the third limit value, first latching element 140 engages over second latching element 142, which is designed as a latching tab and is formed on one of housing shells 28, 30. Restart lockout 138 is also present here, and it may be removed only by mechanically releasing the two latching elements 140, 142, for which purpose it is necessary to open housing 22.

In an example of circuit breaker 12, slide 102 is pressed with the aid of adjustment spring 144 against switching element 96, which is held in this way in the closed state. Only when the electrical current conducted with the aid of busbar 36 exceeds the first limit value is the force acting between yokes 124, 128, 130, 132 and assigned armatures 116, 118, 120, 122 sufficient to move slide 102 away from switching element 96 against the force applied with the aid of adjustment spring 144, in this case, switching element 96 being designed to be opened in a monostable manner, so that switching element 96 is opened by slide 102, due to the lack of loading. This results in a termination of the supply of current to electrical drive 84. For example, control unit 92 is present, or it is omitted, so that the supply of current to electrical drive 84 is set with the aid of auxiliary connection 98. In this case, electrical drive 84 advantageously also has the two different states.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A circuit breaker comprising:
a busbar to which a fixed contact is connected;
a contact bridge to which a moving contact is connected movable in relation thereto;
an electrical drive via which the contact bridge is driven;
a yoke arranged around the busbar; and
a movably supported slide to which an armature is connected, and designed such that, when an electrical current conducted via the busbar exceeds a first limit value, the slide is moved between the armature and the yoke due to a magnetic interaction, so that a switching element, which is electrically connected in series to the electrical drive, is actuated with the aid of the slide.

2. The circuit breaker according to claim 1, wherein the switching element is a mechanical switching contact.

3. The circuit breaker according to claim 2, further comprising a control unit, with the aid of which a second switching element, which is electrically connected in series to the switching element is actuated when the electrical current conducted via the busbar exceeds a second limit value, the second limit value being less than or equal to the first limit value, and the mechanically switching contact being designed to be closed in a monostable manner.

4. The circuit breaker according to claim 1, wherein the slide is spring-loaded, an active force being set with the aid of an adjustment screw.

5. The circuit breaker according to claim 1, further comprising a restart lockout, which has a first latching element provided with the aid of the slide and a fixed second latching element in relation to the switching element, and which is designed such that, the two latching elements are latched after a movement of the slide due to an electrical current conducted via the busbar that is higher than a third limit value, which is greater than or equal to the first limit value, so that the switching element is actuated.

6. The circuit breaker according to claim 1, wherein the yoke has an opening, and wherein the opening and the armature are wedge-shaped.

7. The circuit breaker according to claim 1, wherein the contact bridge and the slide are supported in parallel to each other such that, during a movement of the slide, the slide mechanically strikes a coupling rod connected to the contact bridge, due to an electrical current conducted via the busbar which is higher than a fourth limit value, which is greater than the first limit value, so that a force is applied to the contact bridge, which is oriented away from the fixed contact.

8. The circuit breaker according to claim 7, wherein the contact bridge and the slide are supported in parallel to each other in such a way that the slide strikes the coupling rod only after the switching element is actuated.

9. The circuit breaker according to claim 1, further comprising:
a further busbar to which a further fixed contact is connected;
a further moving contact connected to the contact bridge;
a further yoke placed around the further busbar; and
a further armature connected to the slide.

10. The circuit breaker according to claim 1, further comprising:
a second busbar, to which a second fixed contact is connected;
a second moving contact connected to a second contact bridge;
a second yoke placed around the second busbar; and
a second armature connected to the slide,
wherein the two contact bridges are connected to a shared, movably supported contact bridge carrier.
